(19) United States
(12) Patent Application Publication
(10) Pub. No.: US 2025/0237775 A1
(43) Pub. Date: Jul. 24, 2025

(54) SEISMIC DATA RECONSTRUCTION USING CORRECTED LOCAL TRAVELTIME OPERATORS

(71) Applicant: Saudi Arabian Oil Company, Dhahran (SA)

(72) Inventors: Yimin Sun, Den Haag (NL); Rolf Huibert Baardman, Rotterdam (NL)

(21) Appl. No.: 18/418,982

(22) Filed: Jan. 22, 2024

(51) Int. Cl. G01V 1/30; E21B 44/00

(52) U.S. Cl. CPC G01V 1/305; E21B 44/00; G01V 2210/59; G01V 2210/6222

(57) ABSTRACT

A computer-implemented method includes: accessing a set of seismic data comprising a plurality of data traces received at the receivers in response to an acoustic wave being launched into a subterranean region of interest at the geophysical exploration site; estimating local traveltime operators, each associated with a sample point on the plurality of data traces; correcting at least one local traveltime operator based on, at least in part, statistical features of other local traveltime operators associated with sample points that are adjacent to the sample point associated with the at least one local traveltime operator; reconstructing a stack of wavefronts described by the at least one corrected local traveltime operator; and performing a weighted sum of the reconstructed stack of wavefronts so that an image of a wavefield in the subterranean region of interest is formed and visualized with sufficient clarity to facilitate decision making at the geophysical exploration site.

### TECHNICAL FIELD

This disclosure generally relates to processing and visualization of field seismic data.

### BACKGROUND

Field seismic data is often acquired during geophysical exploration in various industries, such as oil and gas, environmental studies, and civil engineering. The acquisition process generally involves deploying seismic sources and receivers in the field to measure the response of the subsurface to generated seismic wave. Seismic data reconstruction can be a major step during geophysical exploration that involves the restoration of seismic signals or images to enhance the quality of data acquired from seismic surveys.

### SUMMARY

In one aspect, the implementations provide a computer-implemented method that includes: accessing an input set of seismic data acquired from receivers placed at a geophysical exploration site, the input set of seismic data comprising a plurality of data traces recorded at the receivers in response to launching, at a vibration source, an acoustic wave into a subterranean region of interest at the geophysical exploration site; estimating local traveltime operators for the plurality of data traces, wherein each local traveltime operator describes a traveltime characteristic for a wavefront of the acoustic wave to travel from the vibration source, through the subterranean region of interest, and recorded as a sample point in one of the plurality of data traces; correcting at least one local traveltime operator based on, at least in part, statistical features of traveltime characteristics described by other local traveltime operators associated with sample points that are adjacent to the sample point associated with the at least one local traveltime operator; reconstructing a stack of wavefronts described by the at least one corrected local traveltime operator; and performing a weighted sum of the reconstructed stack of wavefronts so that a wavefield image of the acoustic wave in the subterranean region of interest is formed and visualized with sufficient clarity to facilitate decision making at the geophysical exploration site.

Implementations may include one or more of the following features.

Said reconstructing may include interpolating a missing data point in the stack of wavefronts using a linear interpolation based on at least two closest neighbors of the missing data point. Said interpolating may include using a linear-bilinear interpolation that interpolates a missing data point based on two data points each interpolated by a respective linear interpolation. Said reconstructing may include taking an average of a first data point interpolated using the linear interpolation and a second data point interpolated using the linear-bilinear interpolation. The weighted sum may be performed on wavefronts with overlapping apertures. The weighted sum may be defined by non-uniform weights. The wavefield image may include a kinematic sequence of wavefronts propagating through the subterranean region of interest. The method may further include: identifying, using a seismic interpretation workstation, a drilling target based, at least in part, on the wavefield image; and planning, using a well planning system, a wellbore trajectory guided by the drilling target. The traveltime operator may include a quadratic function in two orthogonal space dimensions. The quadratic function may be defined by a set of parameters. Estimating the traveltime operator may include identifying an extremum of a semblance cost function associated with the set of parameters. Said estimating may include applying a non-linear beamforming (NLBF) solver to the semblance cost function. The NLBF solver may be enhanced by a genetic algorithm tuned to speed up searching for the extremum of the semblance cost function.

In another aspect, the implementations provide a computer system comprising one or more hardware computer processors configured to perform operations of: accessing an input set of seismic data acquired from receivers placed at a geophysical exploration site, the input set of seismic data comprising a plurality of data traces recorded at the receivers in response to launching, at a vibration source, an acoustic wave into a subterranean region of interest at the geophysical exploration site; estimating local traveltime operators for the plurality of data traces, wherein each local traveltime operator describes a traveltime characteristic for a wavefront of the acoustic wave to travel from the vibration source, through the subterranean region of interest, and recorded as a sample point in one of the plurality of data traces; correcting at least one local traveltime operator based on, at least in part, statistical features of traveltime characteristics described by other local traveltime operators associated with sample points that are adjacent to the sample point associated with the at least one local traveltime operator; reconstructing a stack of wavefronts described by the at least one corrected local traveltime operator; and performing a weighted sum of the reconstructed stack of wavefronts so that a wavefield image of the acoustic wave in the subterranean region of interest is formed and visualized with sufficient clarity to facilitate decision making at the geophysical exploration site.

The implementations may include one or more of the following features.

Said reconstructing may include interpolating a missing data point in the stack of wavefronts using a linear interpolation based on at least two closest neighbors of the missing data point. Said interpolating may include using a linear-bilinear interpolation that interpolates a missing data point based on two data points each interpolated by a respective linear interpolation. Said reconstructing may include taking an average of a first data point interpolated using the linear interpolation and a second data point interpolated using the linear-bilinear interpolation. The weighted sum may be performed on wavefronts with overlapping apertures. The weighted sum may be defined by non-uniform weights. The wavefield image may include a kinematic sequence of wavefronts propagating through the subterranean region of interest. The operations may further include: identifying, using a seismic interpretation workstation, a drilling target based, at least in part, on the wavefield image; and planning, using a well planning system, a wellbore trajectory guided by the drilling target. The traveltime operator may include a quadratic function in two orthogonal space dimensions. The quadratic function may be defined by a set of parameters. Estimating the traveltime operator may include identifying an extremum of a semblance cost function associated with the set of parameters. Said estimating may include applying a non-linear beamforming (NLBF) solver to the semblance cost function. The NLBF solver may be enhanced by a genetic algorithm tuned to speed up searching for the extremum of the semblance cost function.

Implementations according to the present disclosure may be realized in computer implemented methods, hardware computing systems, and tangible computer readable media. For example, a system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

The details of one or more implementations of the subject matter of this specification are set forth in the description, the claims, and the accompanying drawings. Other features, aspects, and advantages of the subject matter will become apparent from the description, the claims, and the accompanying drawings.

### DESCRIPTION OF DRAWINGS

FIG. 1 depicts an example of a flowchart according to some implementations of the present disclosure.

FIG. 2 shows an example of a seismic acquisition system configured to acquiring field seismic data pertaining to a subterranean region of interest according to some implementations of the present disclosure.

FIG. 3 shows an example of another flow chart according to some implementations of the present disclosure.

FIG. 4 shows an example of a schematic of several wavefronts described by corrected local traveltime operators according to some implementations of the present disclosure.

FIG. 5 illustrates examples of linear-bilinear interpolation to reconstruct missing data points according to some implementations of the present disclosure.

FIG. 6 illustrates an example of weighted summation of reconstructed wavefronts according to some implementations of the present disclosure.

FIGS. 7A to 7F compare and contrast examples of the time section results of data processing according to some implementations of the present disclosure and using other approaches.

FIGS. 8A to 8F compare and contrast examples of the inline section results of data processing according to some implementations of the present disclosure and using other approaches.

FIGS. 9A to 9F compare and contrast examples of the crossline section results of data processing according to some implementations of the present disclosure and using other approaches.

FIG. 10 is a block diagram illustrating an example including both one or more field operations and one or more computational operations according to some implementations of the present disclosure.

FIG. 11 is another block diagram illustrating an example of a computer system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The disclosure is directed to system and method to robustly reconstruct spatially sparse seismic data using corrected local traveltime operators to describe local kinematic wavefronts. An exemplary method can include estimating local traveltime operators from the input data, correcting erroneous local traveltime operators via a statistics-assisted method, performing reconstruction on kinematic wavefronts described by the corrected local traveltime operators, and generating an output based on, at least in part, the weighted summation of all reconstructed data traces. Using a test data set representative of challenging conditions, the implementations demonstrate marked improvement when compared to the reconstruction results using a control method.

During geophysical explorations, field seismic data can be acquired by deploying seismic sources and placing receivers. A typical geophysical exploration can involve a seismic survey to determine the layout of seismic sources and receiver arrays, taking into account the geological setting, potential hydrocarbon prospects, and the characteristics of the area. Seismic sources such as vibrators or explosives can generate controlled seismic waves. For example, Vibroseis trucks equipped with large vibrating plates are often used for land surveys, while marine surveys might deploy air guns or water guns. Geophones or accelerometers, acting as seismic receivers, can be strategically placed across the survey area. The receivers are positioned in a grid pattern or along survey lines to capture the reflected seismic waves. The seismic source is activated, launching seismic waves that travel through the subsurface. These waves interact with different rock layers, reflecting back towards the surface. Geophones record the arrival times and amplitudes of the reflected waves. The resulting data, known as seismic traces, represent the subsurface response at each receiver location.

Field seismic data is usually spatially sparse because the receivers are generally positioned relatively far apart. For example, the source-receiver offset can be significant (e.g., ranging from a few hundred meters to several kilometers) to provide information about deeper subsurface layers and improve the resolution of seismic images. The receiver spacing can range from a few meters to several tens of meters. To cover a wide area with a limited number of receivers, larger spacing may be preferred. Similar considerations are applicable for receiver line interval (i.e., the distance between adjacent survey lines) and receiver array size (i.e., the lateral extent of the receiver array).

The sparsely spaced field seismic data (e.g., in terms of source-receiver offset, inter-receiver spacing, and receiver line interval) presents a challenge to data interpretation during geophysical exploration. For example, the sparsity can give rise to difficulty in visualizing the kinematic wavefronts, interpreting subsurface structures, and hence decision-making in resource exploration.

To address the technical challenge, implementations of the present disclosure can reconstruct sparse seismic data via corrected local traveltime operators. Specifically, the implementations can robustly reconstruct spatially sparse seismic data using corrected local traveltime operators to describe local kinematic wavefronts. An exemplary method can include estimating local traveltime operators from the input data, correcting erroneous local traveltime operators via a statistics-assisted method, performing reconstruction on kinematic wavefronts described by the corrected local traveltime operators, and generating an output based on, at least in part, the weighted summation of all reconstructed data traces. Using a test data set representative of challenging conditions, the implementations demonstrate marked improvement when compared to the reconstruction results using a control method.

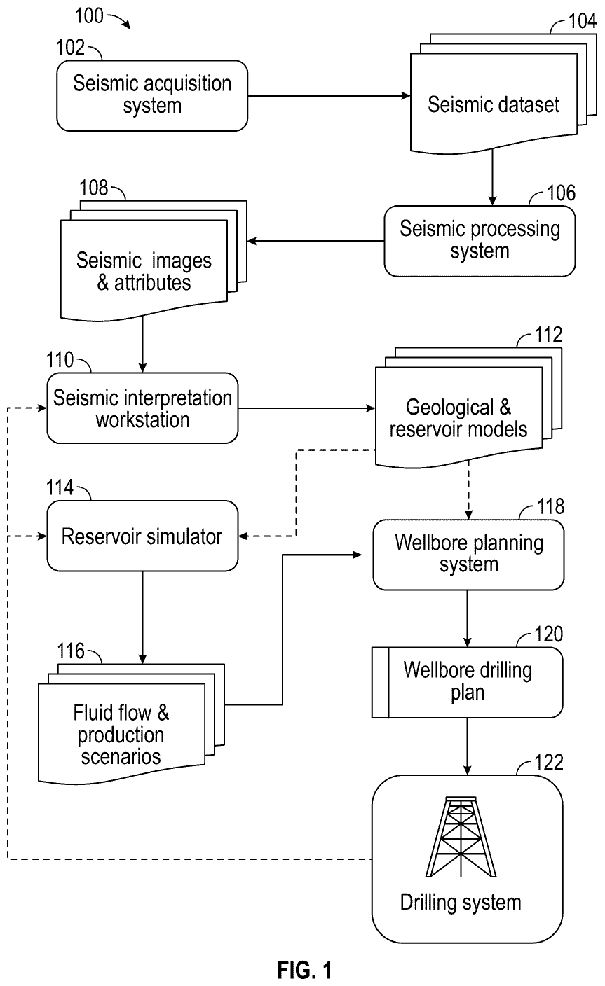

Indeed, as demonstrated below in association with FIGS. 1-6, 7A-7F, 8A-8F, 9A-9F, and 10-11, the implementations can provide vivid and high-definition visualization of a propagating wavefield in a subterranean region of interest so that underground features within the subterranean region of interest can be revealed with improved clarity and data interpretation can be performed with increased confidence. For this reason alone, the implementations are directed to an improvement in computer-related technology.

To generate the vivid and high-definition visualization of the propagating wavefield, the implementations leverage a non-linear beamforming (NLBF) solver to a cost function when estimating local traveltime operators. The NLBF solver is enhanced by a genetic algorithm with control parameters tuned to speed up the computational efficiency for estimating the local traveltime operators. For this reason alone, the implementations improve an existing technological process in terms of computational efficiency.

The implementations further incorporate identifying erroneous local traveltime operators based on, e.g., statistic features of the estimated traveltime operators. The error-correcting aspects further demonstrate that the implementations improve the relevant existing technology by providing improved accuracy when reconstructing the stack of wavefronts used to generate the kinematic sequence of propagating wavefield for output.

FIG. 1 depicts a flowchart (100) in accordance with some implementations of the present disclosure. FIG. 1 illustrates the steps of acquiring remote sensing data, processing the remote sensing data, forming a geological model, optionally simulating the flow of fluids, including hydrocarbons, though the geological model, the planning of wellbores including their surface position, trajectories, and targets, and the drilling of those wellbores. Although the steps in flowchart (100) are shown in sequential order, it will be apparent to one of ordinary skill in the art, that some steps may be conducted in parallel, or in a different order than shown, or may be omitted without departing form the scope of the subject matter.

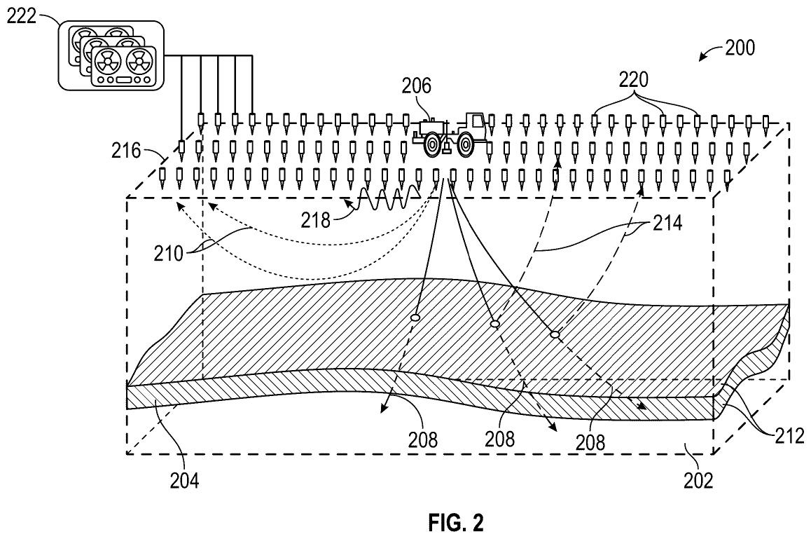

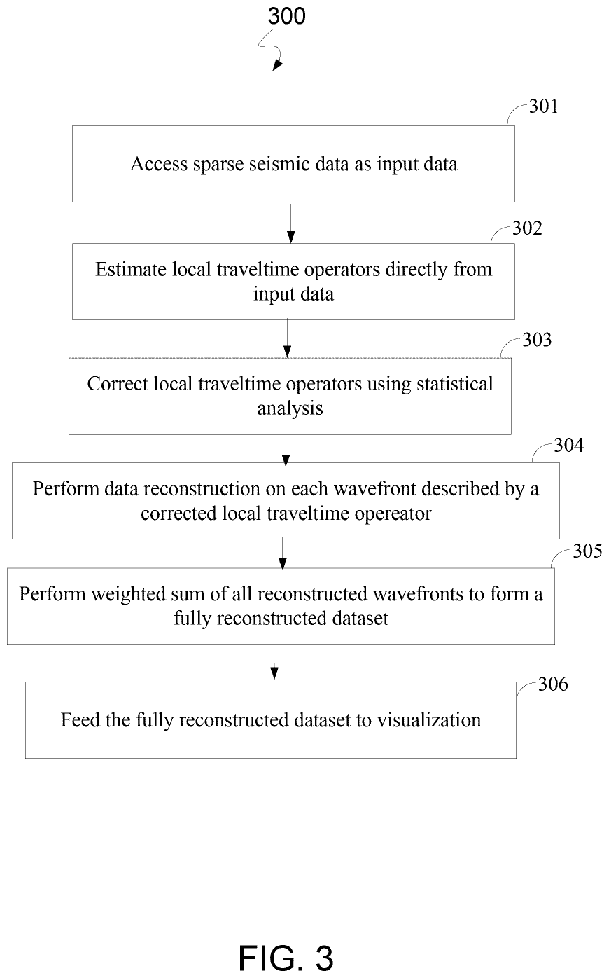

For example, flowchart (100) may begin with the use of a seismic acquisition system (102) to acquire a seismic dataset (104) over a subterranean region of interest. The seismic acquisition system (102) will be described in more detail in the context of FIG. 2, and an example of a seismic dataset is shown in FIG. 3. Other remote sensing datasets may also be collected at this stage to characterize the subterranean region of interest. For example, resistivity, transient electromagnetic, and/or gravitation surveys may be collected.

The seismic dataset contains seismic recordings that are influenced by the geological structure of the subterranean region. However, seismic datasets (104) also contain a wide variety of noise and distortion and does not in its unprocessed “raw” form display significant useful information about the subterranean region. Consequently, seismic datasets (104) are typically processed to remove or attenuate noise and to correctly locate geological boundaries that reflect seismic waves (“seismic reflectors” in two-dimensional (“2D”) or three-dimensional (“3D”) space within the subterranean region.

To determine earth structure, including the presence of hydrocarbons, the seismic data set must be processed. Processing a seismic dataset includes a sequence of steps designed to correct for near-surface effects, attenuate noise, compensate for irregularities in the seismic survey geometry, calculate a seismic velocity model, image reflectors in the subterranean and calculate a plurality of seismic attributes to characterize the subterranean region of interest to determine a drilling target. Each of these steps may be accompanied by one or more quality control steps. Critical steps in processing seismic data include beam forming and seismic migration. Seismic migration is a process by which seismic events are re-located in either space or time to their true subsurface positions.

It will be appreciated by one of ordinary skill in the art that seismic datasets (104) are extremely large, typically occupying hundreds of Terabytes or more than a Petabyte in size, (corresponding to between 10 trillion (10¹³) and 100 trillion (10¹⁴) data samples) and cannot be manipulated or “processed” without the assistance of a purpose configured seismic processing system (106).

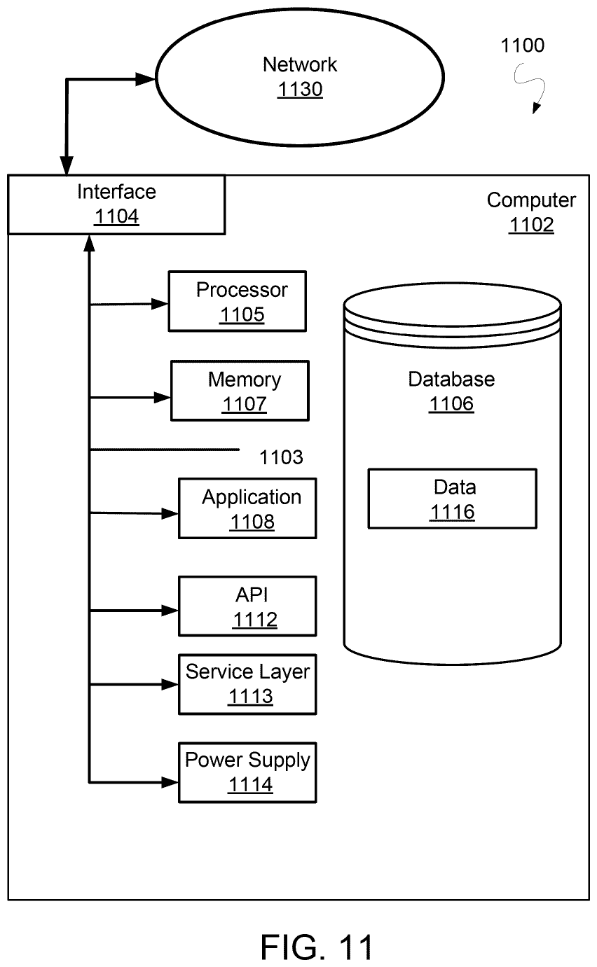

A seismic processing system (106) may be composed of a computer system, such as the computer system shown in FIG. 11. However, a seismic processing system will typically be configured with appropriate seismic processing software and augmented with a number of purpose specific elements, such as high capacity tape drives or hard drives connected through high-speed buses to computer processing units (“CPUs”). Further the CPUs of a seismic processing system will typically be connected to a plurality of graphical processing units (“GPUs”) that perform many of the computationally intensive operations on the seismic dataset (104), banks of high-speed tape, or hard-drive, readers to read the data from storage, high-speed tape or hard-drive writers to output final or intermediate results, and high-speed communication buses to connect these elements.

The result of processing a seismic dataset (104) with a seismic processing system (106) is a seismic image (108). The seismic image is a 2D or 3D image of the points within the subsurface that generate a distinctive seismic response. For example, the seismic image (108) may display the points at which seismic energy is reflected, or scattered, within the subsurface. Other seismic characteristic or “attributes” of the subsurface may be displayed as a seismic image (108). For example, the strength of conversion of energy from one type of seismic wave to another, or the strength of absorption of seismic energy, or the velocity of seismic propagation may be displayed as a function of subsurface position in the seismic image (108). The examples of seismic attributes given above are purely illustrative, and a person of ordinary skill in the art will appreciate that anyone of dozens of other attributes may be displayed as a seismic image (108) and the examples described should not be interpreted as limiting the scope of the inventive subject matter.

The seismic image (108) is an image, typically composed of pixels of varying intensity, and is not itself a model of the geological structure of the subterranean region to which it pertains. To determine the geological structure corresponding to, or that produced, the seismic image (108) the seismic image (108) is typically “interpreted” using a seismic interpretation workstation (110).

A seismic interpretation system (110) is primarily used by geoscientists, seismic interpreters, and exploration teams in the oil and gas industry for analyzing seismic data to understand subsurface geological structures. Seismic interpreters use the workstation to visualize seismic data, including 2D and 3D seismic volumes, cross-sections, time slices, and attribute maps. These visualizations provide insights into subsurface structures, faults, and potential hydrocarbon reservoirs. Additional data may be used within the seismic interpretation workstation (110) to facilitate the interpretation of the seismic dataset. Such additional data may include well logs acquired from previously drilled wells and acquired either while-drilling or via wireline conveyed well logging tools after drilling. Such data may also include non-seismic remote sensing datasets such as resistivity, transient electromagnetic, and/or gravitational surveys.

Interpreters may pick and interpret key geological horizons within seismic data to identify stratigraphic layers, boundaries, and structural features. Horizon interpretation tools and workflows allow for the accurate extraction of geological information from seismic volumes. For example, a seismic interpretation system (110) enables interpreters to identify and interpret subsurface faults that may impact hydrocarbon reservoirs. Fault interpretation tools and visualization techniques help in understanding fault geometry, connectivity, and spatial relationships. Seismic attributes, such as amplitude, frequency, and gradient, provide additional information about subsurface properties and can be analyzed using various algorithms and statistical methods. Attribute analysis tools in the workstation aid in defining reservoir characteristics, identifying anomalies, and highlighting potential hydrocarbon traps.

Interpreters may use the seismic interpretation system (110) to build 3D geological models by integrating seismic data with well-log data, geological knowledge, and other geophysical information. These models help in estimating reservoir properties, optimizing well locations, and predicting hydrocarbon distribution. Interpreters may analyze and characterize hydrocarbon reservoirs by integrating different data sources, including seismic data, well logs, production data, and seismic inversion results. Workstations provide tools for reservoir property estimation, quantitative analysis, and reservoir performance evaluation.

The seismic interpretation system (110) may facilitate prospect generation and evaluation, where interpreters identify and assess areas with high hydrocarbon exploration potential. They can perform detailed geological and geophysical analysis, identify drilling targets, and quantify the risk and uncertainty associated with potential prospects. Finally, workstations enable interpreters to collaborate with team members, share interpretation results, and communicate findings effectively. Interpretation software allows for the creation of reports, annotated images, and presentations to communicate geological interpretations to stakeholders.

The seismic interpretation system (110) can be instrumental for geoscientists involved in exploration and production activities, helping them make informed decisions about drilling locations, optimize production strategies, and understand complex subsurface geological structures. The seismic interpretation system (110) may be a specialized computer system used by geoscientists and seismic interpreters for analyzing and interpreting seismic data.

Seismic interpretation involves intensive tasks like data visualization, horizon picking, attribute analysis, and 3D modeling. A high-performance seismic interpretation system (110) with a powerful processor, ample memory, and a high-resolution display is essential to handle these computationally demanding tasks efficiently. Dedicated GPUs may be crucial for real-time rendering of seismic data, enabling smooth and interactive visualization. GPUs with high memory and parallel processing capabilities accelerate tasks like volume rendering and horizon visualization.

Seismic interpretation often involves working with large and complex datasets. Multiple high-resolution monitors allow interpreters to view seismic data, cross-sections, time slices, attribute maps, and other visualizations simultaneously, enhancing productivity and analysis accuracy. The seismic interpretation system (110) may be equipped with industry-standard software applications tailored for seismic interpretation, such as seismic data processing and visualization tools, horizon and fault interpretation systems, attribute analysis software, and 3D modeling software.

Seismic interpretation projects generate substantial amounts of data, including seismic volumes, processed data, interpretation results, and velocity models. A high-capacity and fast storage system, such as solid-state drives (SSDs) or RAID arrays, is necessary to store and access this data efficiently. The seismic interpretation system (110) often requires network connectivity to access centralized data repositories, collaborate with colleagues, and share interpretation results. A robust network infrastructure with fast Ethernet or fiber connections ensures smooth data transfer and collaboration capabilities.

Essential peripherals like keyboards, mice, and graphics tablets enable efficient interaction with data and software interfaces. A seismic interpretation workstation (110) may be augmented with purpose specific peripherals such as high capability display devices that may include immersive or virtual reality devices, such as virtual-reality headsets or immersive “caves”. Additionally, color-calibrated and high-accuracy input devices enhance the precision of interpretation tasks like picking horizons or drawing geological features. The seismic interpretation system (110) should have backup solutions in place to protect valuable data from loss or damage. Automated backup systems, external storage devices, or network-attached storage (NAS) can be utilized to ensure data safety. In some cases, seismic interpreters may need remote access to the seismic interpretation system (110) or collaborate with colleagues remotely. Setting up remote access capabilities, such as Virtual Private Networks (VPNs) or remote desktop solutions, allows interpreters to work from different locations and share their work effectively. The seismic interpretation system (110) may be customized to meet the needs of interpreters and the specific requirements of projects. The hardware specifications may vary based on factors like the complexity of interpretations, the size of datasets, and the software tools utilized.

The result of interpreting the seismic image may be a geological model (112) of the subsurface, including reservoir models of hydrocarbon reservoirs within the subterranean region of interest. Geological models (112) may include the locations of geological interfaces, such as the boundary between volumes (“formations”) containing different rock types (“facies”), and faults and fractures. Geological models may also include descriptions of the characteristics of the different facies including characteristics such as porosity and permeability, and the relative amounts of different fluids, such as gas, oil and brine, within the pores in each facies.

In some embodiments, the geological models (112) may be used directly to create a wellbore drilling plan (120) using a wellbore planning system (118). Such a wellbore drilling plan (120) may contain drilling targets, often geological regions expected to contain hydrocarbons. The wellbore planning system (118) may plan wellbore trajectories to reach the drilling targets while simultaneously avoiding drilling hazard, such as preexisting wellbores, shallow gas pockets, and fault zones, and not exceeding the constraints, such as torque, drag and wellbore curvature, of the drilling system (122). Similarly, the wellbore drilling plan (120) may include a determination of wellbore caliper, and casing points.

The wellbore planning system (118) may include dedicated software stored on a memory of a computer system, such as the computer system shown in FIG. 11. The wellbore plan (120) may be informed by the best available information at the time of planning. This may include models encapsulating subterranean stress conditions, the trajectory of any existing wellbores (which may be desirable to avoid), and the existence of other drilling hazards, such as shallow gas pockets, over-pressure zones, and active fault planes.

The wellbore path may include a starting surface location of the wellbore, or a subsurface location within an existing wellbore, from which the wellbore may be drilled. The wellbore path may further include a terminal location that may intersect with the previously located hydrocarbon reservoir, such as hydrocarbon reservoir (204) shown in FIG. 2. The wellbore path may further still include wellbore geometry information such as wellbore diameter and inclination angle and when each of these change along the depth of the wellbore. If casing is used, the wellbore plan (120) may include casing type or casing depths. Furthermore, the wellbore plan (120) may consider other engineering constraints such as the maximum wellbore curvature (“dog-log”) that a drill string of a drilling system may tolerate and the maximum torque and drag values that the drilling system may provide. The wellbore plan (120) may further define associated drilling parameters, such as the planned depths at which drilling may be paused and casing will be inserted to support the wellbore to prevent formation fluids entering the wellbore and the drilling mud weights (densities) and types that may be used during drilling of the wellbore.

In some implementations, the geological model (112) may be input to a reservoir simulator (114). A reservoir simulator (114) includes functionality for simulating the flow of fluids, including hydrocarbon fluids such as oil and gas, through a hydrocarbon reservoir composed of porous, permeable reservoir rocks in response to natural and anthropogenic pressure gradients. The reservoir simulator (114) may be used to predict changes in fluid flow, including fluid flow into wells penetrating the reservoir as a result of planned well drilling, and/or fluid injection and extraction. For example, the reservoir simulator may be used to predict fluid-flow and production scenarios (116) including changes in hydrocarbon production rate that would result from the injection of water into the reservoir from wells around the reservoirs periphery.

The reservoir simulator (114) may use a geological model or reservoir model (112) that contains a digital description of the physical properties of the rocks as a function of position within the reservoir and the fluids within the pores of the porous, permeable reservoir rocks at a given time. In some embodiments, the digital description may be in the form of a dense 3D grid with the physical properties of the rocks and fluids defined at each node. In some embodiments, the 3D grid may be a cartesian grid, while in other embodiments the grid may be an irregular grid.

The physical properties of the rocks and fluids within the reservoir may be obtained from a variety of geological and geophysical sources. For example, remote sensing geophysical surveys, such as seismic surveys, gravity surveys, and active and passive source resistivity surveys, may be employed. In addition, data collected from well logs acquired in well penetrating the reservoir may be used to determine physical and petrophysical properties along the segment of the well trajectory traversing the reservoir. For example, porosity, permeability, density, seismic velocity, and resistivity may be measured along these segments of wellbore. In accordance with some embodiments, remote sensing geophysical surveys and physical and petrophysical properties determined from well logs may be combined to estimate physical and petrophysical properties for the entire reservoir simulation model grid.

Reservoir simulators can solve a set of mathematical governing equations that represent the physical laws that govern fluid flow in porous, permeable media. For example, the flow of a single-phase slightly compressible oil with a constant viscosity and compressibility pursuant to Darcy's law, the continuity condition and the state equation.

Additional, and more complicated equations are required when more than one fluid, or more than one phase, e.g., liquid and gas, are present in the reservoir. Further, when the physical and petrophysical properties of the rocks and fluids vary as a function of position the governing equations may not be solved analytically and must instead be discretized into a grid of cells or blocks. The governing equations must then be solved by one of a variety of numerical methods, such as, without limitation, explicit or implicit finite-difference methods, explicit or implicit finite element methods, or discrete Galerkin methods.

The fluid flow and production scenarios (116) predicted by the reservoir simulator (114) may then be used by the wellbore planning system (118) to determine the wellbore drilling plan (120).

While a wellbore drilling plan (120) is formed using the best available information at the time at which it is formed, additional information may become available when drilling the wellbore specified by the plan. For example, well logs providing new information about the reservoir structure and characteristic may be acquired while drilling (so-called “logging-while-drilling”(LWD) logs or during drilling pauses in, or at the completion of drilling of, a wellbore specified by the drilling plan (120). These well logs acquired during pauses or at the cessation of drilling may be acquired using wireline or coiled tubing conveyed logging tools. However acquired, these new wells may be used to update geological and reservoir models (112) with the aid of a seismic interpretation workstation or to directly update the reservoir simulation performed by the reservoir simulator (114).

FIG. 2 shows a seismic acquisition system (200) configured to acquiring a seismic dataset pertaining to a subterranean region of interest (202). The subterranean region of interest (202) may or may not contain a hydrocarbon reservoir (204). The purpose of the seismic survey may be to determine whether or not a hydrocarbon reservoir (204) is present within the subterranean region of interest (202).

The seismic acquisition system (200) may utilize a seismic source (206) positioned on the surface of the earth (216). On land the seismic source (206) is typically a vibroseis truck (as shown) or, less commonly, explosive charges, such as dynamite, buried to a shallow depth. In water, particularly in the ocean, the seismic source may commonly be an airgun (not shown) that releases a pulse of high-pressure gas when activated. Whatever its mechanical design, the seismic source (206), when activated, generates radiated seismic waves, such as those whose paths are indicated by the rays (208). The radiated seismic waves may be bent (“refracted”) by variations in the speed of seismic wave propagation within the subterranean region (202) and return to the surface of the earth (216) as refracted seismic waves (210). Alternatively, radiated seismic waves may be partially or wholly reflected by seismic reflectors, at reflection points such as (224), and return to the surface as reflected seismic waves (214). Seismic reflectors may be indicative of the geological boundaries (212), such as the boundaries between geological layers, the boundaries between different pore fluids, faults, fractures or groups of fractures within the rock, or other structures of interest in the seismic for hydrocarbon reservoirs.

At the surface, the refracted seismic waves (210) and reflected seismic waves (214) may be detected by seismic receivers (220). On land a seismic receiver (220) may be a geophone (that records the velocity of ground motion) or an accelerometer (that records the acceleration of ground motion). In water, the seismic receiver may commonly be a hydrophone that records pressure disturbances within the water. Irrespective of its mechanical design or the quantity detected, seismic receivers (220) convert the detected seismic waves into electrical signals, that may subsequently be digitized and recorded by a seismic recorder (222) as a time-series of samples. Such a time-series is typically referred to as a seismic “trace” and represents the amplitude of the detected seismic wave at a plurality of sample times. Usually, the sample times are referenced to the time of source activation and the sample times are referred to as “recording times”. Thus, zero recording time occurs at the moment the seismic source is activated.

Each seismic receiver (220) may be positioned at a seismic receiver location that may be denoted (xᵣ, yᵣ) where x and y represent orthogonal axes, such as North-South and East-West, on the surface of the earth (216) above the subterranean region of interest (202). Thus, the refracted seismic waves (210) and reflected seismic waves (214) generated by a single activation of the seismic source (206) may be represented as a three-dimensional “3D” volume of data with axes (xᵣ, yᵣ, t) where t indicates the recording time of the sample, i.e., the time after the activation of the seismic source (206).

Typically, a seismic survey includes recordings of seismic waves generated by one or more seismic sources (206) positioned at a plurality of seismic source locations denoted (xₛ, yₛ). In some case, a single seismic source (206) may be used to acquire the seismic survey, with the seismic source (206) being moved sequentially from one seismic source location to another. In other cases, a plurality of seismic sources, such as seismic source (206) may be used, each occupying and being activated (“fired”) sequential at a subset of the total number of seismic source locations used for the survey (218). Similarly, some or all of the seismic receivers (220) may be moved between firing of the seismic source (206). For example, seismic receivers (220) may be moved such that the seismic source (206) remains at the center of the area covered by the seismic receivers (220) even as the seismic source (206) is moved from one seismic source location to the next. In other cases, such as marine seismic acquisition (not shown) the seismic source may be towed a short distance behind a seismic vessel and strings of receivers attached to multiple cables (“streamers”) are towed behind the seismic sources. Thus, a seismic dataset, the aggregate of all the seismic data acquired by the seismic survey, may be represented as a five-dimensional volume (four space dimensions and one time dimension) with coordinate axes (xᵣ,yᵣ,yₛyₛ,t).

Undoubtedly, displaying, processing, and interpreting a five dimensional volume may be challenging. The implementations of the present disclosure can address such challenges by specifically using corrected local travetime operators obtained with statistical analysis to reconstruct the complete wavefields from overlapping local wavefronts. FIG. 3 shows an example of a flow chart 300 according to some implementations of the present disclosure. In step 301, the process may access sparse seismic data as input data. In general, the acquired field seismic data from the array of receivers placed on a grid can be referred to as the data traces. As explained above, data reconstruction methods can densify the sparse field seismic data for seismic data processing and imaging.

In step 302, the process may estimate location traveltime operators directly from input data. Local traveltime operators can describe local kinematic wavefronts. For example, local traveltime operators via a second-order mathematical equation can be defined as:

$$Δ t ( x , y ; {x}_{0} , {y}_{0} ) = t ( x , y ) - t ( {x}_{0} , {y}_{0} ) = A \cdot ( x - {x}_{0} ) + B \cdot ( y - {y}_{0} ) + C \cdot ( x - {x}_{0} ) \cdot ( y - {y}_{0} ) + D \cdot {( x - {x}_{0} )}^{2} + E \cdot {( y - {y}_{0} )}^{2} , \qquad ( 1 )$$

where t(x,y) is the traveltime of the trace located at (x,y) in a seismic gather, t(x₀,y₀) is the traveltime of the parameter trace located at (x₀,y₀), and the coefficients {A, B, C, D, E} are the unknown parameters for a seismic kinematic wavefront centered at t(x₀,y₀). The traveltime operators thus represent time delay parameters for a seismic kinematic wavefront centered at t(x₀, y₀). Traveltime operators can be used in many applications of seismic data processing, such as velocity analysis and migration, to permit the combination of samples collected at different spatial locations so that, for example, a full wave field can be reconstructed or synthesized based on the samples taken from a sparse grid.

Some implementations can retrieve an unknown set of coefficients {A, B, C, D, E} of each local traveltime operator by seeking to maximize the semblance-type cost function as shown below:

$$S ( {x}_{0} , {y}_{0} ) = \frac{{\sum }_{j = 1}^{N} {\{ {\sum }_{i = 1}^{M} u [ {x}_{i} , {y}_{i} ; {t}_{j} ( {x}_{0} , {y}_{0} ) + Δ t ( {x}_{i} , {y}_{i} ; {x}_{0} , {y}_{0} ) ] \}}^{2}}{M {\sum }_{j = 1}^{N} {\sum }_{i = 1}^{M} {\{ u [ {x}_{i} , {y}_{i} ; {t}_{j} ( {x}_{0} , {y}_{0} ) + Δ t ( {x}_{i} , {y}_{i} ; {x}_{0} , {y}_{0} ) ] \}}^{2}} , \qquad ( 2 )$$

where u(xᵢ,yᵢ;t) represents a time sample of the trace located at (xᵢ,yᵢ) in seismic data, M is the total amount of traces inside the spatial aperture of the local traveltime operator, and N is the total amount of time samples inside the temporal aperture of the local traveltime operator. The spatial aperture refers to the spatial extent of data traces taken for the computation. Equation (2) is highly nonlinear, which may entail an efficient nonlinear solver to effectively estimate the local traveltime operators. Examples of nonlinear solvers can incorporate nonlinear beamforming and genetic algorithms that leverage the gradual changes of traveltime operators between neighboring parameter traces to improve computational efficiency.

Because Equation (2) is generally solved in a purely data-driven manner, the estimated local traveltime operators may only bear a mathematical sense. However, as local traveltime operators are designed to describe physical local kinematic wavefronts that propagate in the subterrain, such mathematical solutions may not be completely physical. Such dichotomy can compromise data reconstruction quality.

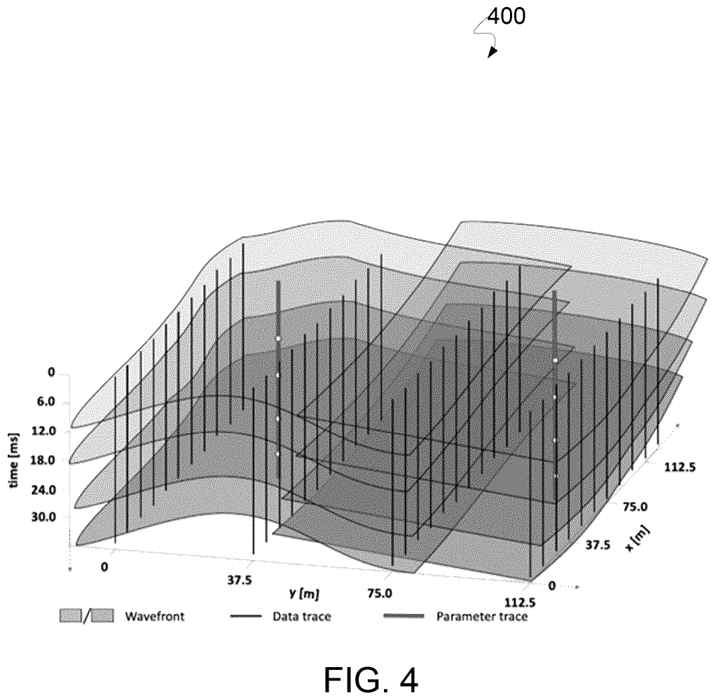

By way of illustration, several physical wavefronts described by the corrected local traveltime operators are depicted in FIG. 4. Here, the wavefront, which corresponds to a physical (e.g., longitudinal) disturbance of the underlying subterrain medium, is illustrated as a set of surfaces stacked along the time axis with each surface spanning the X and Y axes. For simplicity of illustration, an array of thin vertical lines represent the data traces that correspond to the field seismic data acquired at receivers placed in the field in response to, for example, a single seismic source event (e.g., transmission of acoustic disturbance). Similarly, FIG. 4 shows two examples of thick vertical lines that represent parameter traces which connote specific attribute or parameter derived from the seismic data traces. These parameters may include traveltime, amplitude, frequency, or other attributes of the seismic wavefield to provide additional information beyond the raw amplitude values. As explained above, the parameter traces, for example, local traveltime estimates, may not be physical and can hamper the reconstruction of the full wavefronts.

The implementations may first correct erroneous local traveltime operators and then proceed with the data reconstruction step. The correction step may follow a two sub-step procedure. In the first sub-step, the implementations may aim at identifying and removing erroneous operators. This is illustrated by step 303 of FIG. 3, where the process may correct errors in local traveltime operators assisted by statistical analysis. The first sub-step may be assisted by statistics analysis, as erroneous local traveltime operators can be treated as outliers under various statistical criterion, for example, as described in more detail by U.S. application Ser. No. 18/457,286, filed on Aug. 28, 2023, and titled “A method to correct erroneous local traveltime operators.”

In the second sub-step, the implementations may reconstruct the wavefront based upon the remaining operators that make physical sense. Once the correct local traveltime operators are estimated, data reconstruction on these wavefronts can be carried out accordingly, as illustrated in step 304 of FIG. 3. Here, the process may apply the correct local traveltime operator, which represent a time difference characteristic, to align data traces with respect to, for example, a wavefront as illustrated in diagram 400 of FIG. 4.

For a physical wavefront, wavefields on the same wavefront should bear the same phase. In other words, on a given wavefront, the wavefields should be coherent. As a result, carrying out data reconstruction directly in the wavefront domain are physically more accurate. Additionally, the common assumptions behind the data interpolation operation, such as wavefields should change gradually in the spatial domain, can also be better met in the wavefront domain, rather than other domains such as the Fourier domain.

Here, once a wavefront is established via a corrected local traveltime operator, the intersections between the wavefront and available data traces yield the unknown data points on the wavefront. For unknown data points on the wavefront, which belong to the to-be-reconstructed traces in the dataset, the implementations may reconstruct these data points via a linear and bilinear interpolation scheme directly applied on the wavefront to take full average of the linearly interpolated data point and bilinearly interpolated data point as the final reconstructed data value on the wavefront.

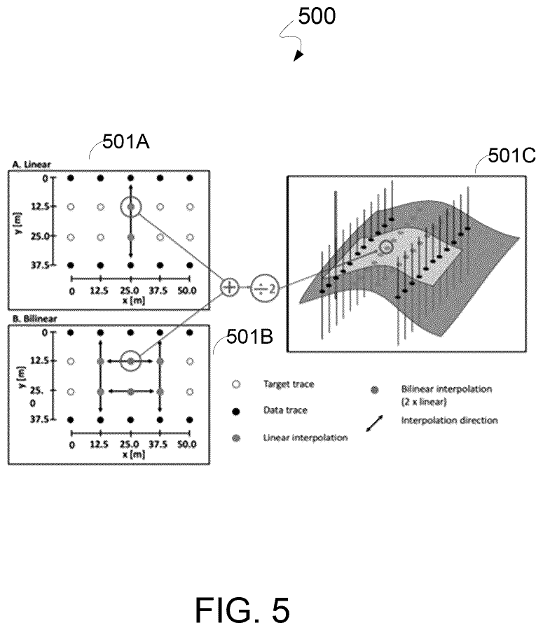

FIG. 5 illustrates an example of a linear-bilinear interpolation scheme 500. Here, linear interpolation, as shown in 501A, operates to interpolate one missing data point using immediate neighbors of this data point in the y direction where there exist known data points in the sparse input data. Bilinear interpolation, as shown in 501B, operates to interpolate one missing data point using immediate neighbors of this data point in the x direction. However, since these neighboring data points, as illustrated in 501C, do not exist in the sparse input data, these neighboring data points can be linearly interpolated first, and then the interpolated data points can be used as the basis for interpolating the data point illustrated in 501B. For this reason, this two-step interpolation is termed as a bilinear interpolation. Notably, if the input data has an irregular data acquisition geometry, then linear interpolation may not be feasible for some to-be-reconstructed points. In this situation, the linear-bilinear interpolation scheme can just fall back to bilinear interpolation alone.

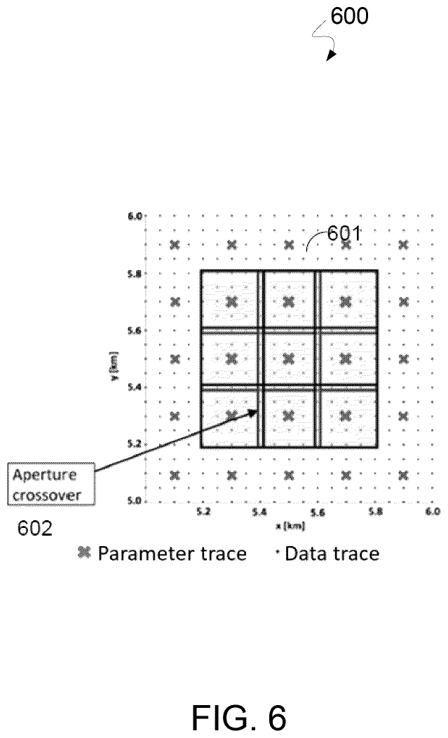

As illustrated in step 305 of FIG. 3, the process may perform weighted summation of reconstructed wavefronts to form a complete reconstructed dataset. During reconstruction, local kinematic wavefronts do overlap, as illustrated in FIG. 4. As a result, once all wavefronts have been fully reconstructed, the process may perform weighted summation of all reconstructed traces to form the final reconstructed dataset. FIG. 6 illustrates an example of diagram 600 of weighted summations for traces belonging to overlapped aperture areas, as indicated by box 602. In this example, traces at area 601 have overlapping wavefronts that can be combined, using weighted summation, to provide a wavefield. The weight function can take different forms which can include a mathematical average, a distance-based weight function. Because different wavefronts overlap in the spatial domain, the implementations can successfully fulfill the data reconstruction task as there will be no to-be-reconstructed trace that is not covered by a wavefront.

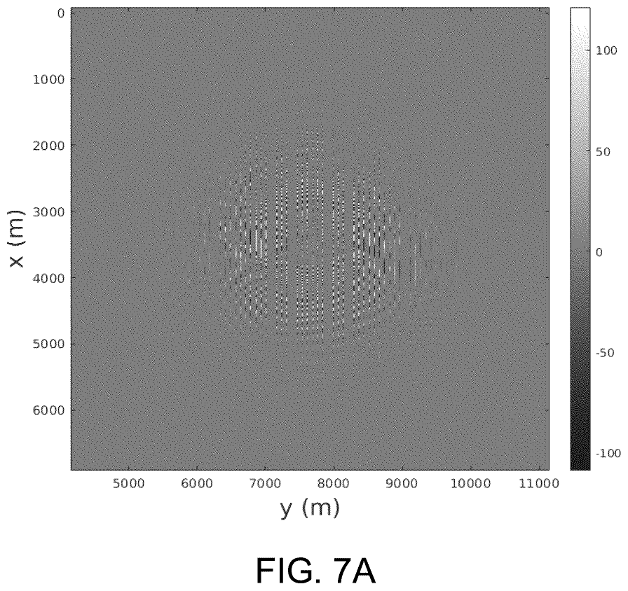

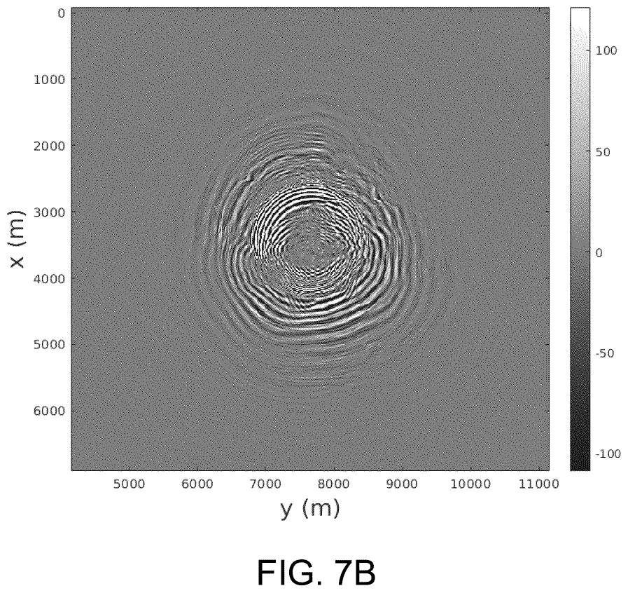

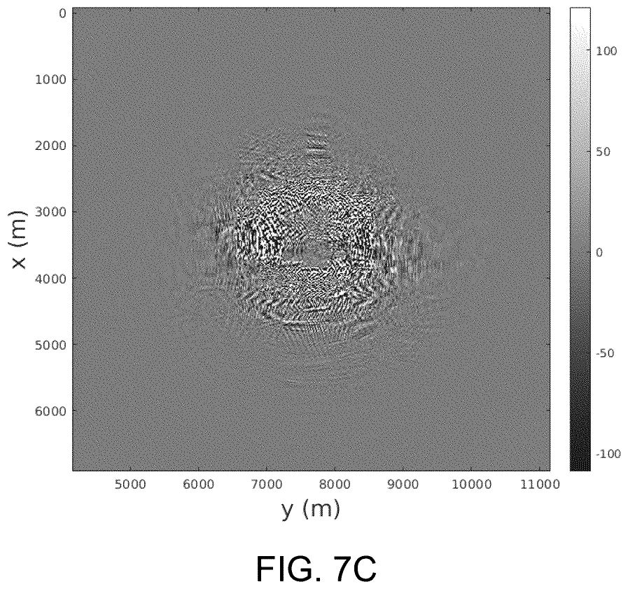

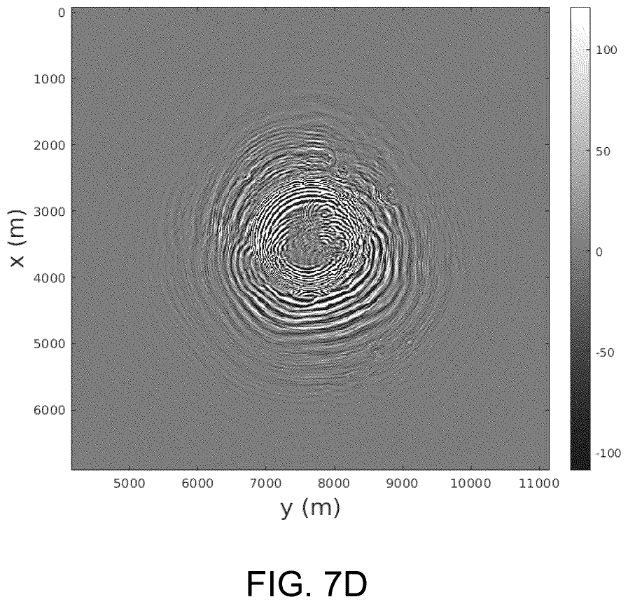

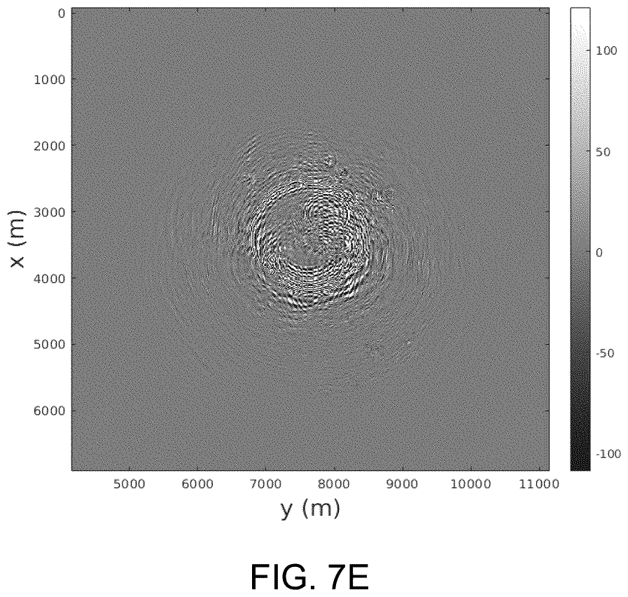

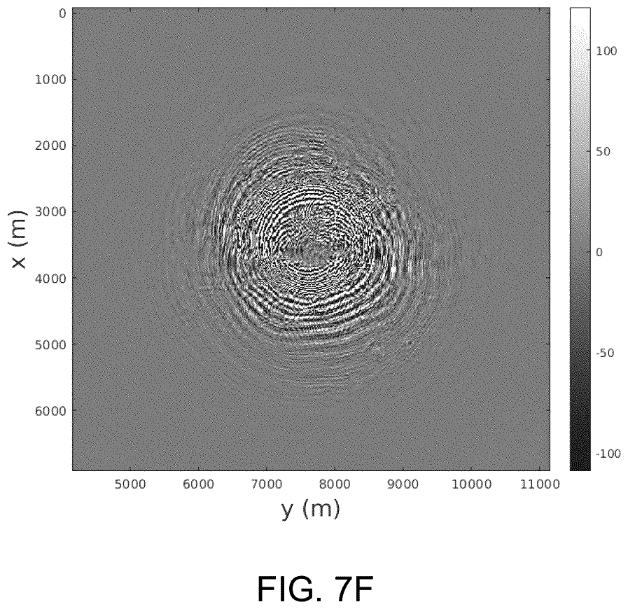

As illustrated in step 306 of FIG. 3, the process may then feed the full reconstructed dataset for visualization, for example, on the display device of a workstation for an operator to review, analyze, and interpret. Examples of the output can be found below in association with FIGS. 7A-7F, 8A-8F, and 9A-9F.

A SEAM Arid dataset has been used as the test bed to demonstrate the efficacy of the implementations. The data acquisition information of this dataset are: inline spacing 12.5 m, crossline spacing 75 m, time sampling rate 6 ms, record length 4.14 s. The local traveltime operators on this dataset are obtained using the following parameters: inline estimation aperture 100 m, crossline estimation aperture 400 m, maximum inline dipping time 150 ms, maximum crossline dipping time 500 ms, parameter trace inline spacing 20 m, parameter trace crossline spacing 40 m, maximum inline time curvature 20 ms, maximum crossline time curvature 80 ms. FIGS. 7A-7F. 8A-8F, and 9A-9F present the results, which further including the results of applying a control method (an existing state-of-the-art reconstruction method) to the same input data.

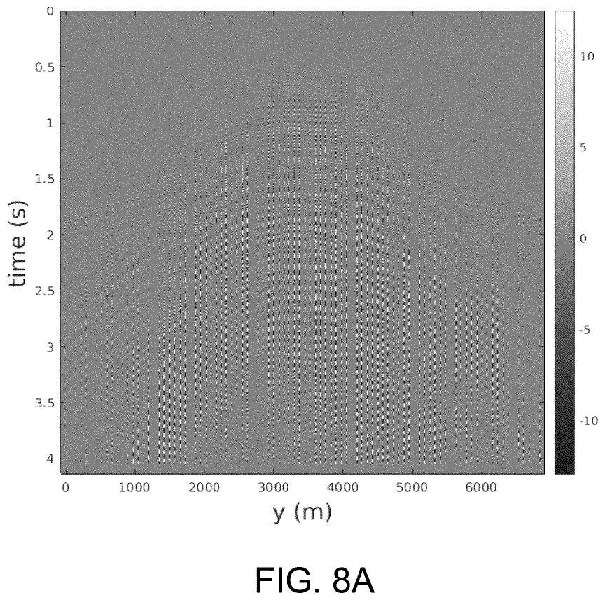

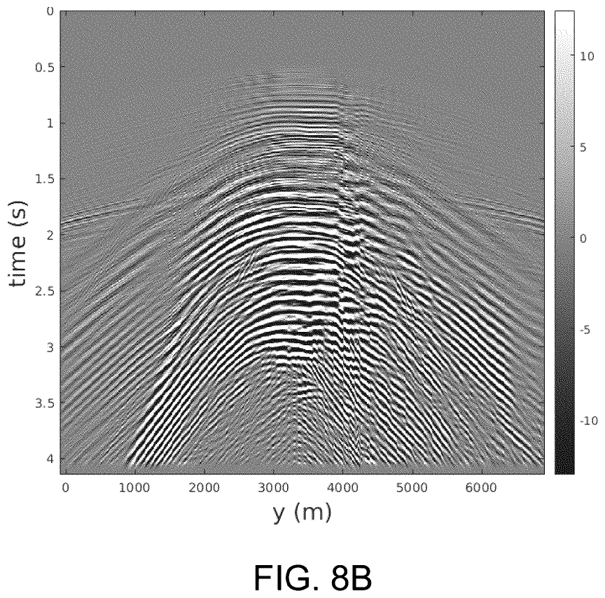

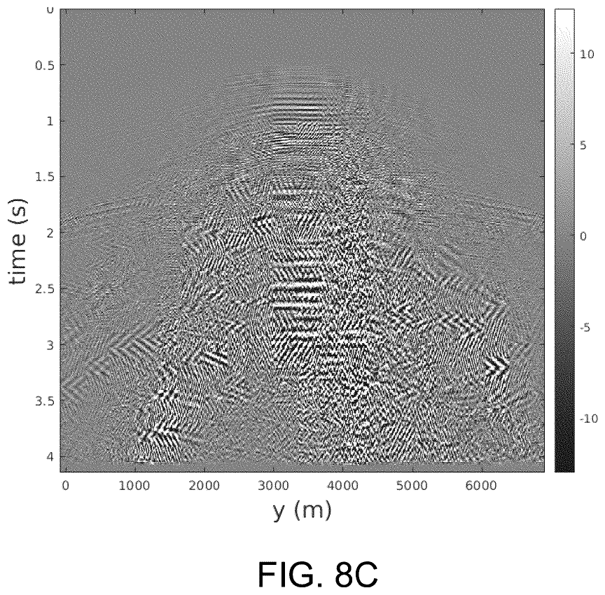

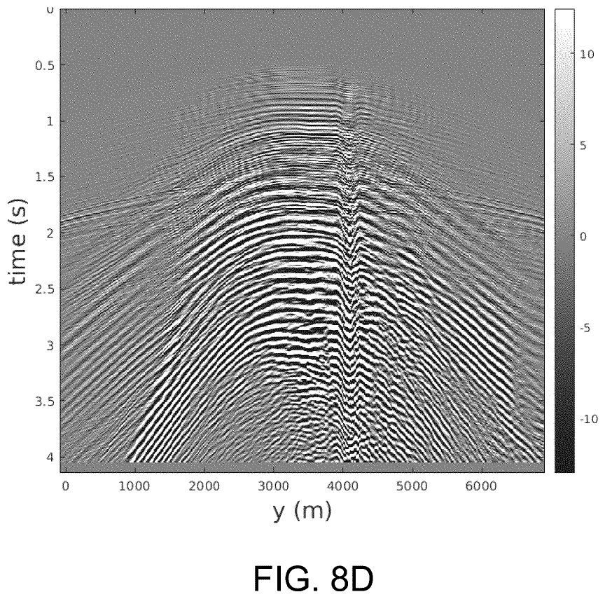

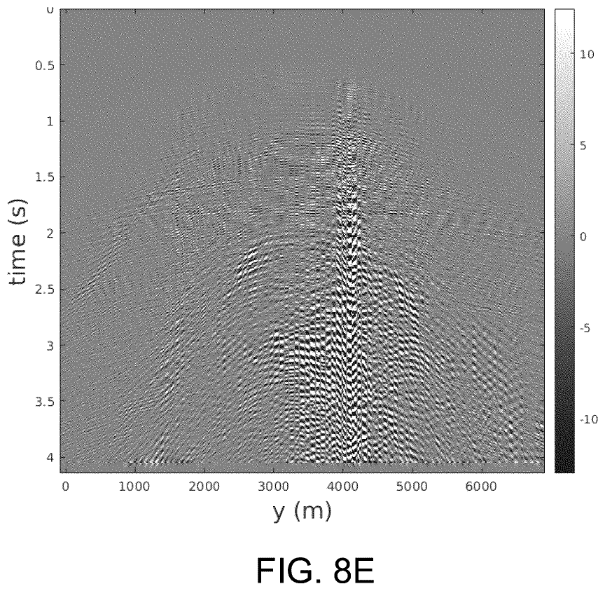

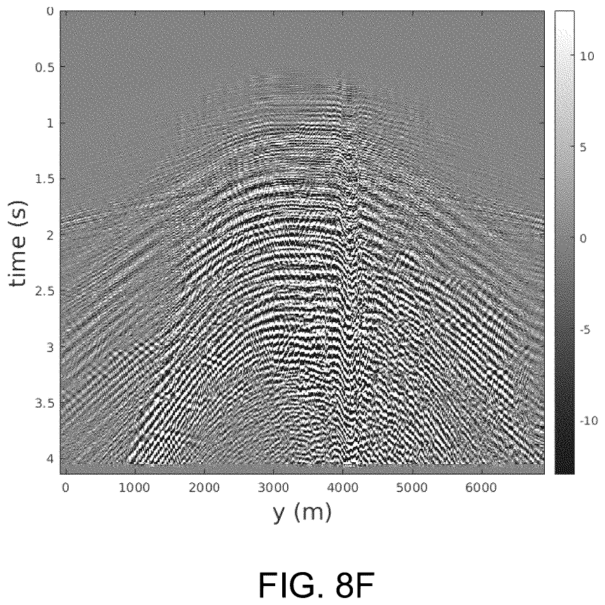

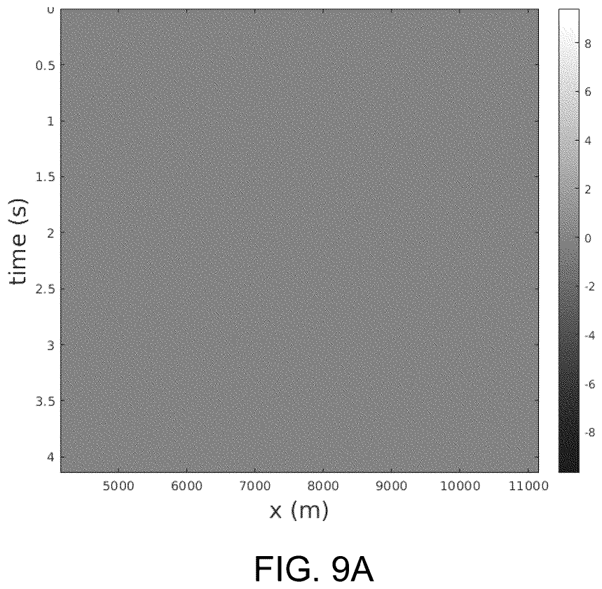

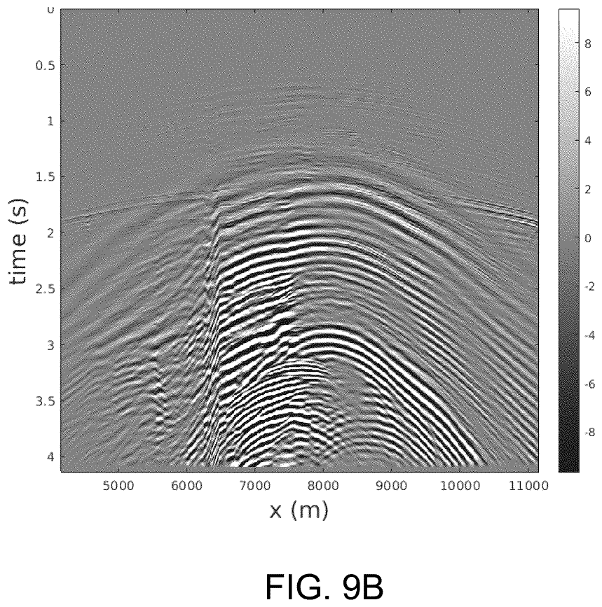

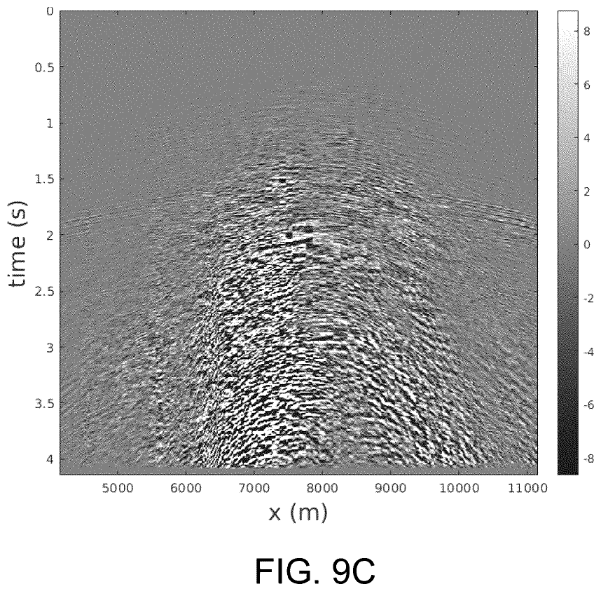

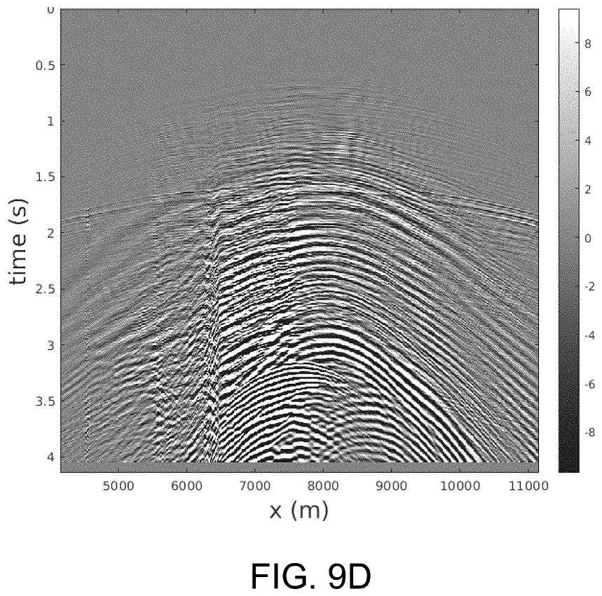

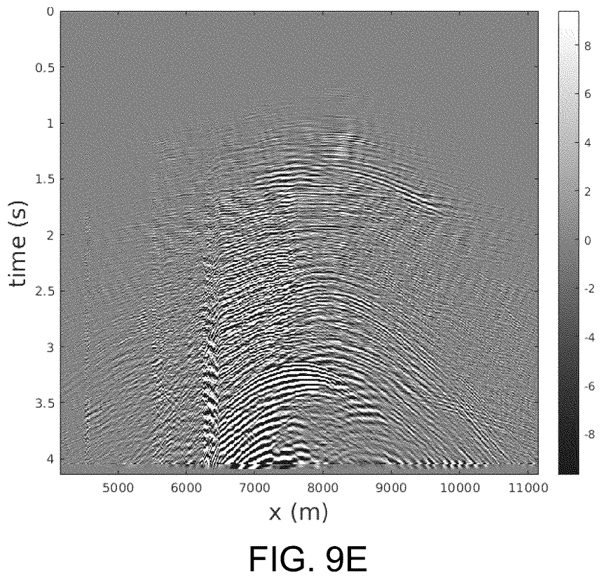

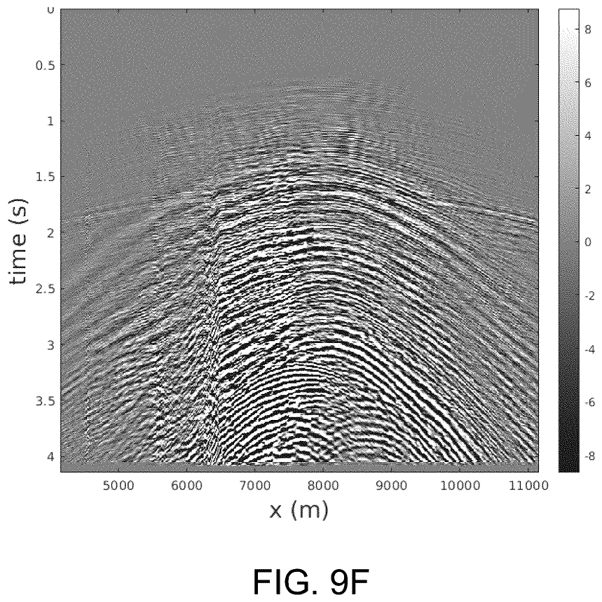

FIGS. 7A-7F show the time section of a dataset. Specifically, FIG. 7A shows input of the sparse input data, with indications of pixelation that hinder data interpretation and image analysis. FIG. 7B shows the results obtained using an implementation of the present disclosure. FIG. 7C shows the results obtained from the control method. FIG. 7D shows the ground truth, which refers to the dataset from which FIG. 7A is decimated. FIG. 7E shows the difference between the ground truth and the reconstructed result of FIG. 7B. FIG. 7F shows the difference between the ground truth and the reconstructed result of FIG. 7C. FIGS. 8A-8F show the inline section while FIGS. 9A-9F correspond to the crossline section. Specifically, FIGS. 8A and 9A show the sparse input data respectively in the inline section and crossline section. FIGS. 8B and 9B show the reconstructed result obtained using an implementation of the present disclosure respectively in the inline section and crossline section. FIGS. 8C and 9C show the reconstructed result using the control method respectively in the inline section and crossline section. FIGS. 8D and 9D show the ground truth respectively in the inline section and crossline section. FIGS. 8E and 9E depict the difference between the ground truth and respectively FIG. 8B and FIG. 9B. FIGS. 8F and 9F depict the difference between the ground truth and respectively FIG. 8C and FIG. 9C. The comparisons thus demonstrate marked improvements over the control method. Such improvements can facilitate decision making for field operations.

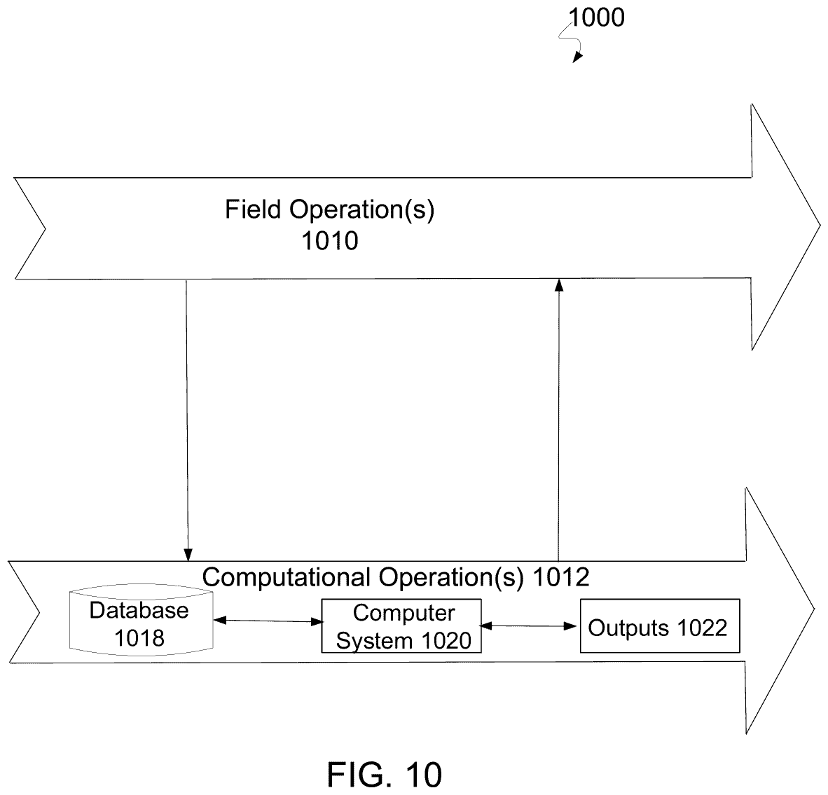

FIG. 10 illustrates hydrocarbon exploration and production operations 1000 that include both one or more field operations 1010 and one or more computational operations 1012, which exchange information and control exploration for the exploration and production of hydrocarbons. In some implementations, outputs of techniques of the present disclosure can be performed before, during, or in combination with the hydrocarbon exploration and production operations 1000, specifically, for example, either as field operations 1010 or computational operations 1012, or both.

Examples of field operations 1010 include surveying operations, forming/drilling a wellbore, hydraulic fracturing, producing through the wellbore, injecting fluids (such as water) through the wellbore, to name a few. In some implementations, methods of the present disclosure can trigger or control the field operations 1010. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 1010 and responsively triggering the field operations 1010 including, for example, generating plans and signals that provide feedback to and control physical components of the field operations 1010. Alternatively or in addition, the field operations 1010 can trigger the methods of the present disclosure. For example, implementing physical components (including, for example, hardware, such as sensors) deployed in the field operations 1010 can generate plans and signals that can be provided as input or feedback (or both) to the methods of the present disclosure.

Examples of computational operations 1012 include one or more computer systems 1020 that include one or more processors and computer-readable media (e.g., non-transitory computer-readable media) operatively coupled to the one or more processors to execute computer operations to perform the methods of the present disclosure. A more detailed example can be found in FIG. 11. The computational operations 1012 can be implemented using one or more databases 1018, which store data received from the field operations 1010 and/or generated internally within the computational operations 1012 (e.g., by implementing the methods of the present disclosure) or both. For example, the one or more computer systems 1020 process inputs from the field operations 1010 to assess conditions in the physical world, the outputs of which are stored in the databases 1018. For example, seismic sensors of the field operations 1010 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 1012 where they are stored in the databases 1018 and analyzed by the one or more computer systems 1020.

In some implementations, one or more outputs 1022 generated by the one or more computer systems 1020 can be provided as feedback/input to the field operations 1010 (either as direct input or stored in the databases 1018). The field operations 1010 can use the feedback/input to control physical components used to perform the field operations 1010 in the real world.

For example, the computational operations 1012 can process the seismic data to generate three-dimensional (3D) maps of the subsurface formation. The computational operations 1012 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 1012 to process new information about the formation and control the drilling to adjust to the observed conditions in real-time.

The one or more computer systems 1020 can update the 3D maps of the subsurface formation as information from one exploration well is received and the computational operations 1012 can adjust the location of the next exploration well based on the updated 3D maps. Similarly, the data received from production operations can be used by the computational operations 1012 to control components of the production operations. For example, production well and pipeline data can be analyzed to predict slugging in pipelines leading to a refinery and the computational operations 1012 can control machine operated valves upstream of the refinery to reduce the likelihood of plant disruptions that run the risk of taking the plant offline.

In some implementations of the computational operations 1012, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

FIG. 11 is a block diagram 1100 illustrating an example of a computer system 1100 used to provide computational functionalities associated with described algorithms, methods, functions, processes, flows, and procedures, according to an implementation of the present disclosure. The illustrated computer 1102 is intended to encompass any computing device such as a server, desktop computer, laptop/notebook computer, wireless data port, smart phone, personal data assistant (PDA), tablet computing device, one or more processors within these devices, another computing device, or a combination of computing devices, including physical or virtual instances of the computing device, or a combination of physical or virtual instances of the computing device. Additionally, the computer 1102 can comprise a computing device that includes an input device, such as a keypad, keyboard, touch screen, another input device, or a combination of input devices that can accept user information, and an output device that conveys information associated with the operation of the computer 1102, including digital data, visual, audio, another type of information, or a combination of types of information, on a graphical-type user interface (UI) (or GUI) or other UI.

The computer 1102 can serve in a role in a computer system as a client, network component, a server, a database or another persistency, another role, or a combination of roles for performing the subject matter described in the present disclosure. The illustrated computer 1102 is communicably coupled with a network 1130. In some implementations, one or more components of the computer 1102 can be configured to operate within an environment, including cloud-computing-based, local, global, another environment, or a combination of environments.

The computer 1102 is an electronic computing device operable to receive, transmit, process, store, or manage data and information associated with the described subject matter. According to some implementations, the computer 1102 can also include or be communicably coupled with a server, including an application server, e-mail server, web server, caching server, streaming data server, another server, or a combination of servers.

The computer 1102 can receive requests over network 1130 (for example, from a client software application executing on another computer 1102) and respond to the received requests by processing the received requests using a software application or a combination of software applications. In addition, requests can also be sent to the computer 1102 from internal users, external or third-parties, or other entities, individuals, systems, or computers.

Each of the components of the computer 1102 can communicate using a system bus 1103. In some implementations, any or all of the components of the computer 1102, including hardware, software, or a combination of hardware and software, can interface over the system bus 1103 using an application programming interface (API) 1112, a service layer 1113, or a combination of the API 1112 and service layer 1113. The API 1112 can include specifications for routines, data structures, and object classes. The API 1112 can be either computer-language independent or dependent and refer to a complete interface, a single function, or even a set of APIs. The service layer 1113 provides software services to the computer 1102 or other components (whether illustrated or not) that are communicably coupled to the computer 1102. The functionality of the computer 1102 can be accessible for all service consumers using this service layer. Software services, such as those provided by the service layer 1113, provide reusable, defined functionalities through a defined interface. For example, the interface can be software written in JAVA, C++, another computing language, or a combination of computing languages providing data in extensible markup language (XML) format, another format, or a combination of formats. While illustrated as an integrated component of the computer 1102, alternative implementations can illustrate the API 1112 or the service layer 1113 as stand-alone components in relation to other components of the computer 1102 or other components (whether illustrated or not) that are communicably coupled to the computer 1102. Moreover, any or all parts of the API 1112 or the service layer 1113 can be implemented as a child or a sub-module of another software module, enterprise application, or hardware module without departing from the scope of the present disclosure.

The computer 1102 includes an interface 1104. Although illustrated as a single interface 1104 in FIG. 11, two or more interfaces 1104 can be used according to particular needs, desires, or particular implementations of the computer 1102. The interface 1104 is used by the computer 1102 for communicating with another computing system (whether illustrated or not) that is communicatively linked to the network 1130 in a distributed environment. Generally, the interface 1104 is operable to communicate with the network 1130 and comprises logic encoded in software, hardware, or a combination of software and hardware. More specifically, the interface 1104 can comprise software supporting one or more communication protocols associated with communications such that the network 1130 or interface's hardware is operable to communicate physical signals within and outside of the illustrated computer 1102.

The computer 1102 includes a processor 1105. Although illustrated as a single processor 1105 in FIG. 11, two or more processors can be used according to particular needs, desires, or particular implementations of the computer 1102. Generally, the processor 1105 executes instructions and manipulates data to perform the operations of the computer 1102 and any algorithms, methods, functions, processes, flows, and procedures as described in the present disclosure.

The computer 1102 also includes a database 1106 that can hold data for the computer 1102, another component communicatively linked to the network 1130 (whether illustrated or not), or a combination of the computer 1102 and another component. For example, database 1106 can be an in-memory, conventional, or another type of database storing data consistent with the present disclosure. In some implementations, database 1106 can be a combination of two or more different database types (for example, a hybrid in-memory and conventional database) according to particular needs, desires, or particular implementations of the computer 1102 and the described functionality. Although illustrated as a single database 1106 in FIG. 11, two or more databases of similar or differing types can be used according to particular needs, desires, or particular implementations of the computer 1102 and the described functionality. While database 1106 is illustrated as an integral component of the computer 1102, in alternative implementations, database 1106 can be external to the computer 1102. As illustrated, the database 1106 holds data 1116 including, for example, data encoding the seismic data traced acquired from receivers placed at a geophysical exploration site, as explained in more detail in association with FIGS. 1-6, 7A-7F, 8A-8F, 9A-9F, and 10.

The computer 1102 also includes a memory 1107 that can hold data for the computer 1102, another component or components communicatively linked to the network 1130 (whether illustrated or not), or a combination of the computer 1102 and another component. Memory 1107 can store any data consistent with the present disclosure. In some implementations, memory 1107 can be a combination of two or more different types of memory (for example, a combination of semiconductor and magnetic storage) according to particular needs, desires, or particular implementations of the computer 1102 and the described functionality. Although illustrated as a single memory 1107 in FIG. 11, two or more memories 1107 or similar or differing types can be used according to particular needs, desires, or particular implementations of the computer 1102 and the described functionality. While memory 1107 is illustrated as an integral component of the computer 1102, in alternative implementations, memory 1107 can be external to the computer 1102.

The application 1108 is an algorithmic software engine providing functionality according to particular needs, desires, or particular implementations of the computer 1102, particularly with respect to functionality described in the present disclosure. For example, application 1108 can serve as one or more components, modules, or applications. Further, although illustrated as a single application 1108, the application 1108 can be implemented as multiple applications 1108 on the computer 1102. In addition, although illustrated as integral to the computer 1102, in alternative implementations, the application 1108 can be external to the computer 1102.

The computer 1102 can also include a power supply 1114. The power supply 1114 can include a rechargeable or non-rechargeable battery that can be configured to be either user- or non-user-replaceable. In some implementations, the power supply 1114 can include power-conversion or management circuits (including recharging, standby, or another power management functionality). In some implementations, the power-supply 1114 can include a power plug to allow the computer 1102 to be plugged into a wall socket or another power source to, for example, power the computer 1102 or recharge a rechargeable battery.

There can be any number of computers 1102 associated with, or external to, a computer system containing computer 1102, each computer 1102 communicating over network 1130. Further, the term “client,” “user,” or other appropriate terminology can be used interchangeably, as appropriate, without departing from the scope of the present disclosure. Moreover, the present disclosure contemplates that many users can use one computer 1102, or that one user can use multiple computers 1102.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal, for example, a machine-generated electrical, optical, or electromagnetic signal that is generated to encode information for transmission to a receiver apparatus for execution by a data processing apparatus. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be, or further include special purpose logic circuitry, for example, a central processing unit (CPU), an FPGA (field programmable gate array), or an ASIC (application-specific integrated circuit). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with an operating system of some type, for example LINUX, UNIX, WINDOWS, MAC OS, ANDROID, IOS, another operating system, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and apparatus can also be implemented as, special purpose logic circuitry, for example, a CPU, an FPGA, or an ASIC.

Computers for the execution of a computer program can be based on general or special purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device.

Non-transitory computer-readable media for storing computer program instructions and data can include all forms of media and memory devices, magnetic devices, magneto optical disks, and optical memory device. Memory devices include semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Magnetic devices include, for example, tape, cartridges, cassettes, internal/removable disks. Optical memory devices include, for example, digital video disc (DVD), CD-ROM, DVD+/−R, DVD-RAM, DVD-ROM, HD-DVD, and BLURAY, and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity, a multi-touch screen using capacitive or electric sensing, or another type of touchscreen. Other types of devices can be used to interact with the user. For example, feedback provided to the user can be any form of sensory feedback. Input from the user can be received in any form, including acoustic, speech, or tactile input. In addition, a computer can interact with the user by sending documents to and receiving documents from a client computing device that is used by the user.

The term “graphical user interface,” or “GUI,” can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with the present disclosure), all or a portion of the Internet, another communication network, or a combination of communication networks. The communication network can communicate with, for example, Internet Protocol (IP) packets, Frame Relay frames, Asynchronous Transfer Mode (ATM) cells, voice, video, data, or other information between networks addresses.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what can be claimed, but rather as descriptions of features that can be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method comprising:
accessing an input set of seismic data acquired from receivers placed at a geophysical exploration site, the input set of seismic data comprising a plurality of data traces recorded at the receivers in response to launching, at a vibration source, an acoustic wave into a subterranean region of interest at the geophysical exploration site;
estimating local traveltime operators for the plurality of data traces, wherein each local traveltime operator describes a traveltime characteristic for a wavefront of the acoustic wave to travel from the vibration source, through the subterranean region of interest, and recorded as a sample point in one of the plurality of data traces;
correcting at least one local traveltime operator based on, at least in part, statistical features of traveltime characteristics described by other local traveltime operators associated with sample points that are adjacent to the sample point associated with the at least one local traveltime operator;
reconstructing a stack of wavefronts described by the at least one corrected local traveltime operator; and
performing a weighted sum of the reconstructed stack of wavefronts so that a wavefield image of the acoustic wave in the subterranean region of interest is formed and visualized with sufficient clarity to facilitate decision making at the geophysical exploration site.

2. The computer-implemented method of claim 1, wherein said reconstructing comprises interpolating a missing data point in the stack of wavefronts using a linear interpolation based on at least two closest neighbors of the missing data point.

3. The computer-implemented method of claim 2, wherein said interpolating comprises using a linear-bilinear interpolation that interpolates a missing data point based on two data points each interpolated by a respective linear interpolation.

4. The computer-implemented method of claim 3, wherein said reconstructing comprises taking an average of a first data point interpolated using the linear interpolation and a second data point interpolated using the linear-bilinear interpolation.

5. The computer-implemented method of claim 1, wherein the weighted sum is performed on wavefronts with overlapping apertures.

6. The computer-implemented method of claim 1, wherein the weighted sum is defined by non-uniform weights.

7. The computer-implemented method of claim 1, wherein the wavefield image comprises a kinematic sequence of wavefronts propagating through the subterranean region of interest.

8. The computer-implemented method of claim 1, further comprising:
identifying, using a seismic interpretation workstation, a drilling target based, at least in part, on the wavefield image; and
planning, using a well planning system, a wellbore trajectory guided by the drilling target.

9. The computer-implemented method of claim 1, wherein the traveltime operator comprises a quadratic function in two orthogonal space dimensions,
wherein the quadratic function is defined by a set of parameters, and
wherein estimating the traveltime operator comprises identifying an extremum of a semblance cost function associated with the set of parameters.

10. The computer-implemented method of claim 9, wherein said estimating comprises applying a non-linear beamforming (NLBF) solver to the semblance cost function, and
wherein the NLBF solver is enhanced by a genetic algorithm tuned to speed up searching for the extremum of the semblance cost function.

11. A computer system comprising one or more hardware computer processors configured to perform operations of:
accessing an input set of seismic data acquired from receivers placed at a geophysical exploration site, the input set of seismic data comprising a plurality of data traces recorded at the receivers in response to launching, at a vibration source, an acoustic wave into a subterranean region of interest at the geophysical exploration site;
estimating local traveltime operators for the plurality of data traces, wherein each local traveltime operator describes a traveltime characteristic for a wavefront of the acoustic wave to travel from the vibration source, through the subterranean region of interest, and recorded as a sample point in one of the plurality of data traces;
correcting at least one local traveltime operator based on, at least in part, statistical features of traveltime characteristics described by other local traveltime operators associated with sample points that are adjacent to the sample point associated with the at least one local traveltime operator;
reconstructing a stack of wavefronts described by the at least one corrected local traveltime operator; and
performing a weighted sum of the reconstructed stack of wavefronts so that a wavefield image of the acoustic wave in the subterranean region of interest is formed and visualized with sufficient clarity to facilitate decision making at the geophysical exploration site.

12. The computer system of claim 11, wherein said reconstructing comprises interpolating a missing data point in the stack of wavefronts using a linear interpolation based on at least two closest neighbors of the missing data point.

13. The computer system of claim 12, wherein said interpolating comprises using a linear-bilinear interpolation that interpolates a missing data point based on two data points each interpolated by a respective linear interpolation.

14. The computer system of claim 13, wherein said reconstructing comprises taking an average of a first data point interpolated using the linear interpolation and a second data point interpolated using the linear-bilinear interpolation.

15. The computer system of claim 11, wherein the weighted sum is performed on wavefronts with overlapping apertures.

16. The computer system of claim 11, wherein the weighted sum is defined by non-uniform weights.

17. The computer system of claim 11, wherein the wavefield image comprises a kinematic sequence of wavefronts propagating through the subterranean region of interest.

18. The computer system of claim 11, further comprising:
a seismic interpretation workstation configured to identify a drilling target based, at least in part, on the image; and
a well planning system configured to plan a wellbore trajectory guided by the drilling target.

19. The computer system of claim 11, wherein the traveltime operator comprises a quadratic function in two orthogonal space dimensions,
wherein the quadratic function is defined by a set of parameters, and
wherein estimating the traveltime operator comprises identifying an extremum of a semblance cost function associated with the set of parameters.

20. The computer system of claim 19, wherein said estimating comprises applying a non-linear beamforming (NLBF) solver to the semblance cost function, and
wherein the NLBF solver is enhanced by a genetic algorithm tuned to speed up searching for the extremum of the semblance cost function.
